(19) United States
(12) Patent Application Publication
(10) Pub. No.: US 2004/0010870 A1
(43) Pub. Date: Jan. 22, 2004

(54) Hygienic electric toothbrush

(75) Inventor: John Duncan McNair, Hong Kong (HK)

Correspondence Address: LEYDIG VOIT & MAYER, LTD, 700 THIRTEENTH ST. NW, SUITE 300, WASHINGTON, DC, 20005-3960, US

(73) Assignee: Chiaphua Industries Limited, Tai Po (HK)

(21) Appl. No.: 10/199,468

(22) Filed: Jul. 22, 2002

(51) Int. Cl. A61C 17/22

(52) U.S. Cl. 15/22.1

(57) ABSTRACT

A bristle head for an electric toothbrush has a casing, a drive shaft within the casing and a flexible membrane mounted to or formed integrally with the casing. A number of bristle tufts extend from the flexible membrane and roots of each tuft extend into the casing. A transmission is provided for transmitting movement of the drive shaft to the roots of the bristle tufts whereupon the flexible membrane flexes as or the bristle tufts move. The design prevents toothpaste and other liquid from entering into the casing where it might wear moving parts and harbour bacteria.

### BACKGROUND OF THE INVENTION

The present invention relates to electric toothbrushes. More particularly, although not exclusively, the invention relates to an electric toothbrush having bristles activated to move by a mechanism sealed within the bristle head that is isolated from water, toothpaste and bacteria.

Most electric toothbrushes have gaps between moving parts nearby the bristles at the bristle head. These gaps provide passages through which abrasive toothpaste can pass into the mechanism, causing wear. Also, if saliva and bacteria enter the bristle head through those passages, such can remain inside the bristle head, thereby providing an internal breeding ground for the bacteria. Thorough rinsing of the bristle head exterior has little, if any effect in reducing what remains inside to fester. This is clearly an unhygienic, and therefore undesirable state of affairs.

### OBJECTS OF THE INVENTION

It is an object of the present invention to overcome or substantially ameliorate the above disadvantage and/or more generally to provide an improved electric toothbrush bristle head.

It is a further general object of the present invention to provide an electric toothbrush bristle head having a bristle-moving mechanism sealed therein and thereby isolated from liquid.

Another object of the present invention is to provide an electric toothbrush bristle head having bristles extending through a flexible membrane, which flexible membrane acts as a pivot mounting for the bristles.

### DISCLOSURE OF THE INVENTION

There is disclosed herein a bristle head for a toothbrush, comprising:

a casing,

a drive shaft within the casing,

a flexible membrane mounted to or formed integrally with the casing,

a plurality of bristle tufts extending from the flexible membrane, and

transmission means for transmitting movement of the drive shaft to said bristle tufts whereupon the flexible membrane flexes as the bristle tufts move.

Preferably the bristle tufts pass through the flexible membrane.

Preferably the bristle head further comprises an activator base into which roots of the bristle tufts beneath the flexible membrane are received.

Preferably the activator base includes followers that bear against the drive shaft.

Preferably the drive shaft includes an offset crank portion with which the followers engage.

Alternatively, the drive shaft can include a cam portion with which the followers engage.

Preferably a number of said activator bases are provided alongside one another, each associated with a subset of said bristle tufts, and each adapted to pivot independently upon interaction with the drive shaft.

Preferably the bristle head is formed integrally with an electric toothbrush having a handle housing a battery and a motor and a neck securing the bristle head thereto.

Alternatively, the bristle head can be a replaceable attachment for an electric toothbrush.

### BRIEF DESCRIPTION OF THE DRAWINGS

A preferred form of the present invention will now be described by way of example with reference to the accompanying drawings, wherein:

FIG. 1 is a schematic part cross-sectional perspective illustration of a bristle head in an inverted orientation,

FIG. 2 is a schematic inverted perspective illustration of parts of the bristle ahead of FIG. 1,

FIG. 3 is a schematic parts-exploded inverted perspective illustration of the bristle head of FIG. 1,

FIG. 4 is a schematic parts-exploded perspective illustration of the bristle head of FIG. 1,

FIG. 5 is a schematic plan view of the bristle head of FIGS. 1 to 4,

FIG. 6 is a schematic cross-sectional elevational view of the bristle-head taken at VI-VI in FIG. 5,

FIG. 7 is a schematic cross-sectional elevational view of the bristle-head taken at VII-VII in FIG. 6,

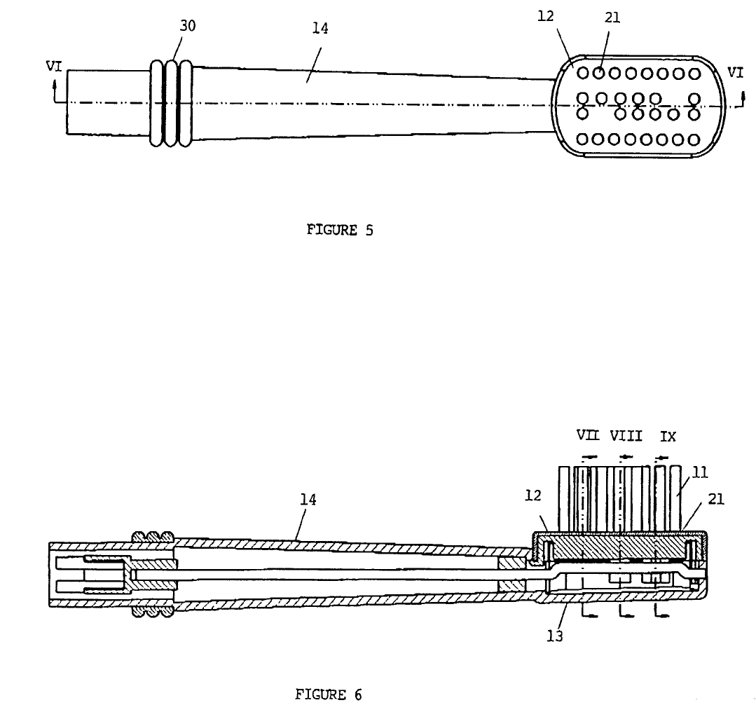

FIG. 6 is a schematic cross-sectional elevational view of the bristle-head taken at VI-VI in FIG. 6,

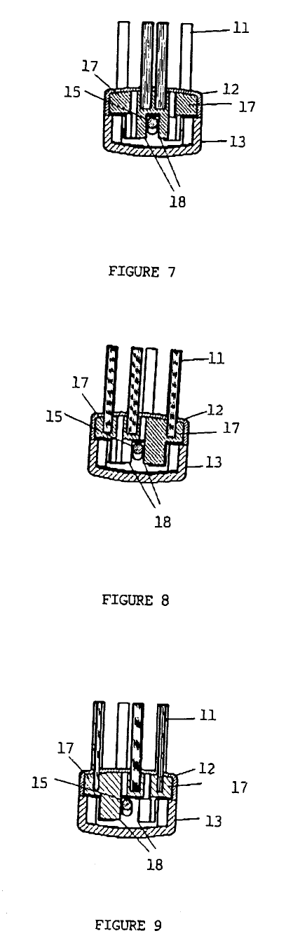

FIG. 7 is a schematic cross-sectional elevational view of the bristle-head taken at VII-VII in FIG. 6,

FIG. 8 is a schematic cross-sectional elevational view of the bristle-head taken at VIII-VIII in FIG. 6, and

FIG. 9 is a schematic cross-sectional elevational view of the bristle-head taken at IX-IX in FIG. 6.

### DESCRIPTION OF THE PREFERRED EMBODIMENT

In the accompanying drawings there is schematically depicted a bristle head 10 for an electric toothbrush. The bristle head 10 is typically made of moulded hard plastics material such as, but not limited to ABS, or polypropylene and includes a number of bristle tufts 11 passing through a flexible membrane 12. Flexible membrane 12 is formed of resilient plastics material, such as, but not limited to TPE (synthetic rubber), Latex, natural rubber, or any flexible, appropriately strong and durable material.

The flexible membrane 12 is attached securely and sealed to a casing 13 formed of moulded plastics material. The casing 13 is formed integrally with a neck 14. The flexible membrane 12 has a periphery 27 that can be fitted tightly to the casing to form a sealed engagement therewith. Alternatively, the periphery 27 of the flexible membrane can be glued, plastics-welded or otherwise sealed to the casing. As yet a further alternative, the flexible membrane 12 could extend the whole way about the casing 12 to thereby encase it. It could even extend around the neck 14, or at least a portion thereof.

Extending longitudinally through the neck 14 is a drive shaft 19. Beneath the bristle tufts 11, the drive shaft 19 includes an offset crank portion 15. The distal end 26 of the drive shaft 19 is located within an aperture formed in the casing 13. This aperture need not pass the whole way through the casing 13.

The flexible membrane 12 has a number of holes 21 through which individual bristle tufts 11 pass. Holes 21 and bristle tufts 11 are so dimensioned that a fluid-tight seal is formed between the membrane and the bristle tufts.

The bottom ends or “roots” of the bristle tufts are received within respective activator bases 17 positioned directly behind the flexible membrane 12. Glue or sealant can be provided amongst and/or about the bristles at the root of each tuft to seal against the flexible membrane and/or in holes formed in each activator base within which the roots are received.

There are three activator bases 17 in the depicted embodiment. With reference to FIG. 4, the activator bases 17 extend in a length-wise direction of the bristle head and are separated from one another by longitudinal gaps 22. The activator bases 22 are typically formed of moulded plastics material in a single die. To this end, two thin bridges 20, one at each end of the activator bases, remain from plastics-flow passages in the die and can stay in place in the finished product upon severing of thin legs 26. These thin legs also remain from further flow passages in the die. Alternatively, the bridges 20 can be discarded.

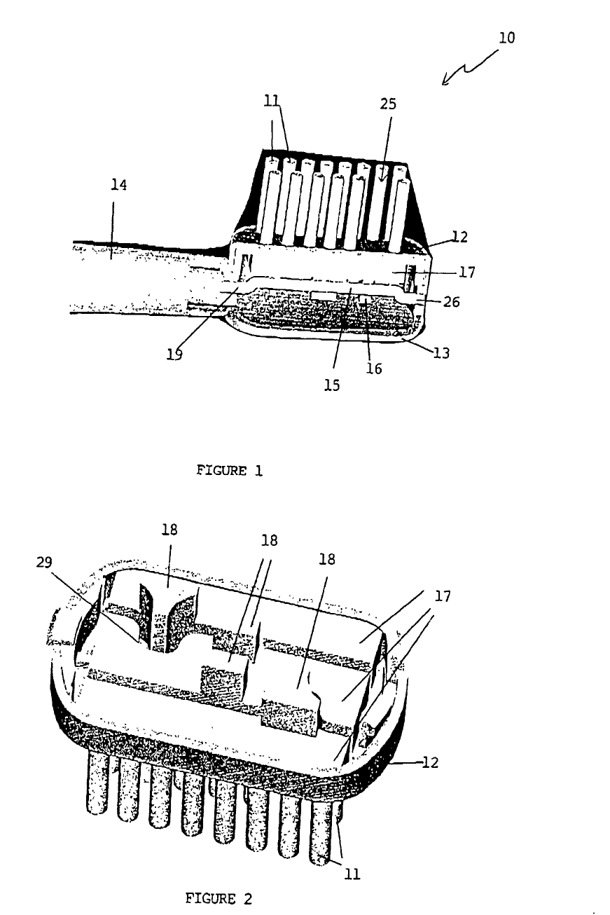

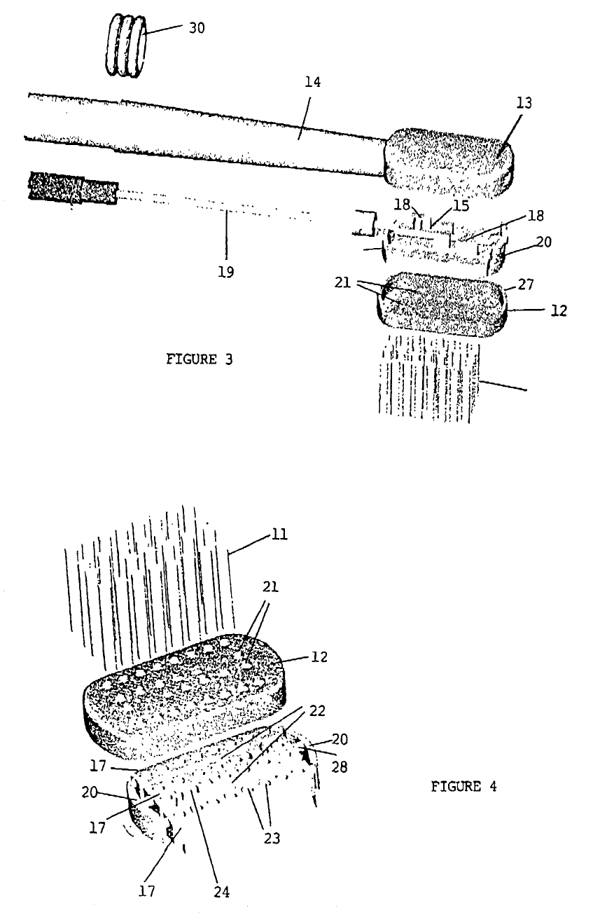

Each activator base 17 has formed integrally therewith one or more followers 18. The centre-most activator base 17 can have a pair of followers 18 inbetween which the crank portion 15 of drive shaft 19 passes. Each of the outboard activator bases 17 can have a follower 18 to bear against the crank portion 15. These outboard followers 18 extend into a recess 29 formed in the centre-most activator base 17. Because of this recess 29, there is a missing tuft block 25 as shown in FIG. 1.

A coloured ring 30 can be attached about the base of the neck 14 to aid in identifying the apparatus as that of a particular individual.

In use, the drive shaft 19 is continuously rotated or pivotally oscillated back and forth about its longitudinal axis by a motor in a toothbrush handle from which the neck 14 extends. As a result, the eccentric crank portion 15 bears against the followers 18 to cause the followers to move laterally back and forth. The holes 21 where the bristle tufts pass through the flexible membrane serve as hinge points for the bristle tufts. The bristle tufts will therefore pivot about axes, which extend parallel to the length-wise longitudinal axis of the bristle head. In the depicted embodiment, each activator base and its associated bristles will pivot in unison.

During use of the bristle head, the crank portion and other internal moving parts are protected from toothpaste and other liquid, as there is nowhere for the same to enter the casing.

It should be appreciated that modifications and alterations obvious to those skilled in the art are not to be considered as beyond the scope of the present invention. For example, instead of a continuous crank portion 15, individual cams having their lobes pointing in different directions, or shorter crank portions extending in different radial directions can be employed to thereby cause the individual activator bases and associated bristles to oscillate differently from one another.

1. A bristle head for a toothbrush, comprising:
a casing,
a drive shaft within the casing,
a flexible membrane mounted to or formed integrally with the casing,
a plurality of bristle tufts extending from the flexible membrane, and
transmission means for transmitting movement of the drive shaft to said bristle tufts whereupon the flexible membrane flexes as the bristle tufts move.

2. Be bristled head of claim 1, wherein the bristle tufts pass through the flexible membrane.

3. The bristle head of claim 1 further comprising an activator base into which roots of the bristle tufts beneath the flexible membrane are received.

4. The bristle head of claim 3, wherein the activator base includes followers that bear against the drive shaft.

5. The bristle head of claim 4, wherein the drive shaft includes an offset crank portion with which the followers engage.

6. The bristle head of claim 4, wherein the drive shaft includes a cam portion with which the followers engage.

7. The bristle head of claim 3, wherein a number of said activator bases are provided alongside one another, each associated with a subset of said bristle tufts, and each adapted to pivot independently upon interaction with the drive shaft.

8. The bristle head of anyone of the preceding claims being formed integrally with an electric toothbrush having a handle housing a battery and a motor and a neck securing the bristle head thereto.

9. The bristle head of any one of claims 1 to 7 being a replaceable attachment for an electric toothbrush.
